(19) United States
(12) Patent Application Publication
(10) Pub. No.: US 2012/0119983 A2
(43) Pub. Date: May 17, 2012

(54) DISPLAY DEVICE AND METHOD FOR DRIVING SAME

(75) Inventor: Toshihiko MIYASHITA, Nara (JP)

(73) Assignee: Sharp Kabushiki Kaisha, Osaka (JP)

(21) Appl. No.: 12/223,519

(22) PCT Filed: Feb. 1, 2007
(86) PCT No.: PCT/JP2007/051708

§ 371 Date: Aug. 1, 2008

(30) Foreign Application Priority Data
Feb. 22, 2006 (JP) 2006-045634

(51) Int. Cl. G09G 3/36; G02F 1/133; G09G 3/20

(52) U.S. Cl. 345/93

(57) ABSTRACT

A drive order control circuit 14 generates a drive order control signal LR so as to change periodically, such as every frame time or every line time. Based on the drive order control signal LR, a data signal line drive circuit 3 switches between driving data signal lines S1 to Sm in the left-to-right direction in accordance with the disposition order, and driving them in the right-to-left direction in accordance with the disposition order. A memory control circuit 15 switches the order of reading digital video signals Vd from a frame memory 12 in units of one or more lines in accordance with the drive order control signal LR. By changing the order of driving the data signal lines, it becomes possible to disperse any ghost generated on the display screen in the temporal and/or spatial directions, thereby reducing the visibility of the ghost. Thus, it is possible to prevent any ghost from being generated on the display screen of any display device performing dot-sequential drive, in a simple manner other than a two-fold pulse drive method.

### TECHNICAL FIELD

The present invention relates to display devices, and methods for driving the same, and particularly to a matrix-type display device, and a method for driving data signal lines in the matrix-type display device.

### BACKGROUND ART

In some liquid crystal display devices, dot-sequential drive is performed for sequentially driving display elements in accordance with the order of disposition in the scanning signal line direction. FIG. 13 is a block diagram illustrating the configuration of a conventional liquid crystal display device performing dot-sequential drive. In the liquid crystal display device 90 shown in FIG. 13, (m×n) display elements P included in a pixel array 1 are driven in the following manner. A control circuit 91 outputs timing control signals TC1 and TC2, and an address signal ADR. A scanning signal line drive circuit 2 sequentially selects and activates scanning signal lines G1 to Gn based on the timing control signal TC1. A frame memory 12 outputs a digital video signal Vd based on the address signal ADR. A D/A converter 13 converts the digital video signal Vd into an analog video signal Va. The analog video signal Va is applied to data signal lines S1 to Sm via sampling switches SS1 to SSm. A sampling switch control circuit 4 included in a data signal line drive circuit 3 outputs switch control signals C1 to Cm based on the timing control signal TC2 to control the sampling switches SS1 to SSm.

FIG. 14 is a timing chart for the liquid crystal display device 90. The drive method shown in FIG. 14 is herein after referred to as the “one-fold pulse drive method”. In the one-fold pulse drive method, the switch control signals C1 to Cm are sequentially brought into high level every period (herein after, referred to as a “cycle”) in which the digital video signal Vd changes. In the cycle during which the switch control signal C1 is at high level, the sampling switch SS1 is rendered conductive, and the analog video signal Va is applied to the data signal line S1. In this cycle, the data signal line S1 is charged by output voltage of the D/A converter 13. When the switch control signal C1 falls to low level, so that the sampling switch SS1 is rendered non-conductive, the data signal line S1 holds the output voltage of the D/A converter 13.

Similarly, when the switch control signal Ci (where i is an integer from 1 to m) falls from high to low level, the data signal line Si holds the output voltage of the D/A converter 13. The voltage held by each of the data signal lines S1 to Sm is written to a display element P connected to an activated scanning signal line. The light transmitting state of the display element P changes in accordance with the voltage written thereto. In this manner, the liquid crystal display device 90 displays a screen.

However, in the liquid crystal display device 90, two adjacent data signal lines Si and Si+1 are capacitively coupled by parasitic capacitances Csd1 and Csd2 connected in series, as shown in FIG. 15. Therefore, the voltage held by the data signal line Si might fluctuate (rise or fall) when the adjacent data signal line Si+1 is charged. For example, in the example shown in FIG. 16, when the data signal line S2 is charged, the voltage on the data signal line S1 rises by ΔV from the level being held.

In the liquid crystal display device performing dot-sequential drive, the voltage fluctuation as described above occurs on every some number of the data signal lines (in the case of the liquid crystal display device 90, all data signal lines), the number being equal to the number of analog video signals Va supplied to the data signal line drive circuit 3 (in the case of the liquid crystal display device 9Q, one). When such a voltage fluctuation occurs, an image blur called a “ghost” is generated on the display screen.

The ghost becomes conspicuous in a place where the luminance level varies greatly between adjacent pixels in the scanning signal line direction. For example, when attempting to display a screen containing a black rectangular 52 on a white background 51, as shown in FIG. 17A, ghosts 53 and 54 are generated on the left and right sides of the rectangular 52, as shown in FIG. 17B. The reason why the ghost 53 is generated on the left side of the rectangular 52 is because pixels outside the rectangular 52 that should normally appear white are affected by adjacent black pixels on the right, and caused to appear darker. The reason why the ghost 54 is generated on the right side of the rectangular 52 is because pixels inside the rectangular 52 that should normally appear black are affected by adjacent white pixels on the right, and caused to appear lighter.

A conventionally-known method for preventing the ghost is to lengthen the conductive period of the sampling switch. For example, in the drive method shown in FIG. 18 (herein after, referred to as the “two-fold pulse drive method”), the length of period during which the switch control signals C1 to Cm are at high level is twice the length compared to the case of the one-fold pulse drive method (FIG. 14). The data signal line Si is charged for two cycles during which the switch control signal Ci is at high level. Concretely, during the first cycle, the data signal line Si is charged by the voltage supplied to the data signal line Si−1 adjacent thereto, whereas during the second cycle, it is charged by the voltage supplied to the data signal line Si itself.

In the two-fold pulse drive method, the data signal line Si and the adjacent data signal line Si+1 are charged in the same cycle. Therefore, when charging of the adjacent data signal line Si+1 is started, the output voltage of the D/A converter 13 continues to be applied to the data signal line Si. Accordingly, the voltage held by the data signal line Si does not fluctuate even if the adjacent data signal line Si+1 is charged. Thus, the liquid crystal display device employing the two-fold pulse drive method can prevent any ghost from being generated on the display screen.

Note that Patent Document 1 discloses a display device as prior art relevant to the claimed invention of the present application, in which a shift register for line-sequential scanning is of bidirectional type capable of receiving signals from both left and right in order to reverse the left and right sides of the display screen. In addition, Patent Document 2 discloses a display device with secondary data conversion portions each commonly provided for a plurality of signal lines. The secondary data conversion portion distributes display signal voltages so as to be sequentially applied to each signal line, and changes the order of applying the display signal voltages in a predetermined period.
[Patent Document 1] Japanese Laid-Open Patent Publication No. 1-170988
[Patent Document 2] Japanese Laid-Open Patent Publication No. 2005-195703

### DISCLOSURE OF THE INVENTION

### Problems to be Solved by the Invention

In the liquid crystal display device employing the above-described two-fold pulse drive method, two sampling switches each corresponding to one of the adjacent data signal lines are simultaneously rendered conductive, and therefore the load of the two data signal lines is placed on the D/A converter. Accordingly, the liquid crystal display device employing the two-fold pulse drive method requires a buffer with increased drive power to be provided in the output stage of the D/A converter. As a result, the liquid crystal display device employing the two-fold pulse drive method has a problem where power consumption is increased with the drive power of the buffer.

Therefore, an objective of the present invention is to prevent any ghost from being generated on the display screen of any display device performing dot-sequential drive, in a simple manner other than the two-fold pulse drive method.

### Solution to the Problems

A first aspect of the present invention is directed to a matrix-type display device performing dot-sequential drive, comprising:

a pixel array including a plurality of display elements disposed in row and column directions, a plurality of scanning signal lines, each being commonly connected to display elements disposed in the same row, and a plurality of data signal lines, each being commonly connected to display elements disposed in the same column;

a scanning signal line drive circuit for selectively activating the scanning signal lines;

a video signal output portion for sequentially outputting analog video signals to be supplied to the display elements; and

a data signal line drive circuit for driving the data signal lines in accordance with their disposition order based on the analog video signals,

wherein the data signal line drive circuit periodically switches between driving the data signal lines in accordance with the order of disposition in a first direction and driving the data signal lines in accordance with the order of disposition in a second direction, and

wherein the video signal output portion changes the order of outputting the analog video signals in accordance with the order of driving the data signal lines.

In a second aspect of the present invention, based on the first aspect of the invention, the order of driving the data signal lines changes every predetermined number of frames.

In a third aspect of the present invention, based on the first aspect of the invention, the order of driving the data signal lines changes every predetermined number of lines.

In a fourth aspect of the present invention, based on the first aspect of the invention, the order of driving the data signal lines changes every predetermined number of lines and differs from that in an immediately previous frame.

In a fifth aspect of the present invention, based on the first aspect of the invention, the order of driving the data signal lines changes every predetermined number of lines in a pattern different from that in an immediately previous frame.

In a sixth aspect of the present invention, based on the fifth aspect of the invention, the order of driving the data signal lines changes in a pattern different by a predetermined number of lines from that in the immediately previous frame.

In a seventh aspect of the present invention, based on the first aspect of the invention, the video signal output portion includes:

a frame memory for memorizing a digital video signal for at least one frame;

a memory control circuit for reading the digital video signal from the frame memory; and

a D/A converter for converting the digital video signal being read from the frame memory into the analog video signal, and

the memory control circuit changes the order of reading from the frame memory in units of one or more lines in accordance with the order of driving the data signal lines.

In an eighth aspect of the present invention, based on the first aspect of the invention, the video signal output portion includes:

a rearrangement circuit for temporarily memorizing digital video signals sequentially outputted from a signal source, and outputting the memorized digital video signals in units of one or more lines in the same order as or reverse order from that when they were inputted, in accordance with the order of driving the data signal lines; and

a D/A converter for converting the digital video signals being read from the rearrangement circuit into the analog video signals.

A ninth aspect of the present invention is directed to a method for driving data signal lines in a display device with a pixel array including a plurality of display elements disposed in row and column directions, a plurality of scanning signal lines, each being commonly connected to display elements disposed in the same row, and a plurality of data signal lines, each being commonly connected to display elements disposed in the same column, the method comprising the steps of:

sequentially outputting analog video signals to be supplied to the display elements; and

driving the data signal lines in accordance with their disposition order based on the analog video signals,

wherein in the step of driving the data signal lines, switching is periodically performed between driving the data signal lines in accordance with the order of disposition in a first direction and driving the data signal lines in accordance with the order of disposition in a second direction, and

wherein in the step of outputting the analog video signals, the order of outputting the analog video signals is changed in accordance with the order of driving the data signal lines.

### Effect of the Invention

According to the first or ninth aspect of the present invention, the order of driving the data signal lines periodically switches between the order of disposition in the first direction and the order of disposition in the second direction. In matrix-type display devices performing dot-sequential drive, the place where the ghost is generated on the display screen depends on the order of driving the data signal lines. Accordingly, by changing the order of driving the data signal lines, it becomes possible to disperse any ghost generated on the display screen in the temporal and/or spatial directions, thereby reducing the visibility of the ghost. As a result, it is possible to prevent any ghost from being generated on the display screen in a simple manner other than the two-fold pulse drive method.

According to the second aspect of the present invention, it is possible to disperse any ghost generated on the display screen in the temporal direction, thereby reducing the visibility of the ghost.

According to the third aspect of the present invention, it is possible to disperse any ghost generated on the display screen in the scanning signal line direction, thereby reducing the visibility of the ghost.

According to the fourth through sixth aspects of the present invention, it is possible to disperse any ghost generated on the display screen in the temporal direction and the scanning signal line direction, thereby reducing the visibility of the ghost.

According to the seventh aspect of the present invention, it is possible to configure a video signal output portion capable of changing the order of outputting the analog video signals for any display device with a frame memory.

According to the eighth aspect of the present invention, it is possible to configure a video signal output portion capable of changing the order of outputting the analog video signals for any display device used with and connected to a signal source for sequentially outputting digital video signals.

### BRIEF DESCRIPTION OF THE DRAWINGS

FIG. 1 is a block diagram illustrating the configuration of a liquid crystal display device according to a first embodiment of the present invention.

FIG. 2 is a diagram illustrating an example of the order of driving data signal lines in the liquid crystal display device shown in FIG. 1.

FIG. 3 is a diagram illustrating another example of the order of driving data signal lines in the liquid crystal display device shown in FIG. 1.

FIG. 4 is a diagram illustrating another example of the order of driving data signal lines in the liquid crystal display device shown in FIG. 1.

FIG. 5 is a diagram illustrating another example of the order of driving data signal lines in the liquid crystal display device shown in FIG. 1.

FIG. 6 is a diagram illustrating another example of the order of driving data signal lines in the liquid crystal display device shown in FIG. 1.

FIG. 7 is a diagram illustrating another example of the order of driving data signal lines in the liquid crystal display device shown in FIG. 1.

FIG. 8 is an exemplary timing chart for the liquid crystal display device shown in FIG. 1.

FIG. 9 is another exemplary timing chart for the liquid crystal display device shown in FIG. 1.

FIG. 10 is another exemplary timing chart for the liquid crystal display device shown in FIG. 1.

FIG. 11A is an enlarged view of an ideal display screen.

FIG. 11B is an enlarged view of a display screen provided by a conventional liquid crystal display device performing dot-sequential drive.

FIG. 11C is an enlarged view of a display screen provided by the liquid crystal display device shown in FIG. 1.

FIG. 12 is a block diagram illustrating the configuration of a liquid crystal display device according to a second embodiment of the present invention.

FIG. 13 is a block diagram illustrating the configuration of a conventional liquid crystal display device.

FIG. 14 is a timing chart in the case where a one-fold pulse drive method is performed in the liquid crystal display device shown in FIG. 13.

FIG. 15 is a diagram illustrating parasitic capacitances generated between data signal lines in a liquid crystal display device.

FIG. 16 is a diagram illustrating a voltage fluctuation on a data signal line in the case where the one-fold pulse drive method is performed in the liquid crystal display device shown in FIG. 13.

FIG. 17A is a diagram illustrating a correct display screen provided by the liquid crystal display device shown in FIG. 13.

FIG. 17B is a diagram illustrating a display screen provided by the liquid crystal display device shown in FIG. 13, in which ghosts are generated.

FIG. 18 is a timing chart in the case where a two-fold pulse drive method is performed in the liquid crystal display device shown in FIG. 13.

### DESCRIPTION OF THE REFERENCE CHARACTERS

1 pixel array
2 scanning signal line drive circuit
3 data signal line drive circuit
4 sampling switch control circuit
10, 20 liquid crystal display device
11, 21 control circuit
12 frame memory
13 D/A converter
14 drive order control circuit
15 memory control circuit
22 rearrangement circuit
P display element
SS1 to SSm sampling switch
G1 to Gn scanning signal line
S1 to Sm data signal line
C1 to Cm switch control signal
LR drive order control signal
TC1, TC2 timing control signal
ADR address signal
Vd, Vd1, Vd2 digital video signal
Va analog video signal
S signal source

### BEST MODES FOR CARRYING OUT THE INVENTION

### First Embodiment

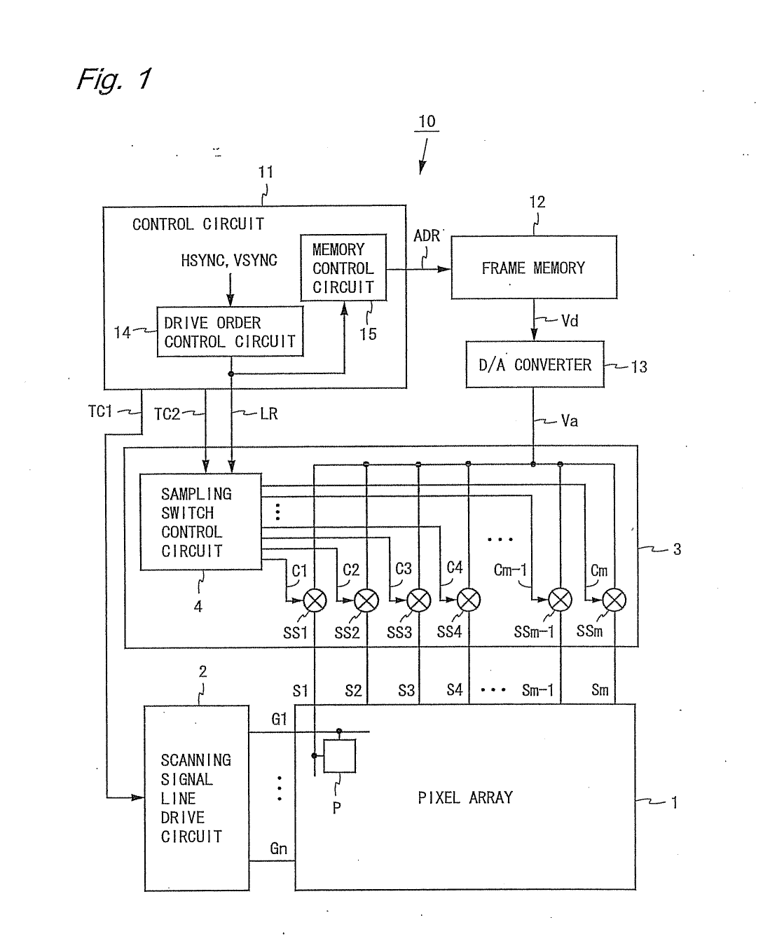

FIG. 1 is a block diagram illustrating the configuration of a liquid crystal display device according to a first embodiment of the present invention. The liquid crystal display device 10 shown in FIG. 1 includes a pixel array 1, a scanning signal line drive circuit 2, a data signal line drive circuit 3, a control circuit 11, a frame memory 12, and a D/A converter 13. The control circuit 11 includes a drive order control circuit 14, and a memory control circuit 15. In FIG. 1, the frame memory 12, the D/A converter 13, and the memory control circuit 15 collectively function as a video signal output portion. Hereinafter, m and n are integers of 1 or higher, and i is an integer from 1 to m.

The pixel array 1 includes (m×n) display elements P, n scanning signal lines G1 to Gn, and m data signal lines S1 to Sm. There are m display elements P arranged in the row direction (horizontal direction in the figure), and n display elements P arranged in the column direction (vertical direction in the figure). The display elements P disposed in the same row are commonly connected to any one of the scanning signal lines G1 to Gn. The display elements P disposed in the same column are commonly connected to any one of the data signal lines S1 to Sm. Note that the subscript assigned to each of the data signal lines S1 to Sm indicates the disposition order of the data signal line.

The control circuit 11 outputs timing control signals TC1 and TC2 to operate the scanning signal line drive circuit 2 and the data signal line drive circuit 3. The drive order control circuit 14 generates a drive order control signal LR to control the order of driving the data signal lines S1 to Sm. The drive order control signal LR is supplied to the data signal line drive circuit 3 and the memory control circuit 15. The memory control circuit 15 outputs an address signal ADR to the frame memory 12.

The scanning signal line drive circuit 2 sequentially selects and activates the scanning signal lines G1 to Gn based on the timing control signal TC1. The frame memory 12 memorizes a digital video signal for at least one frame, and outputs a digital video signal Vd based on the address signal ADR. The D/A converter 13 converts the digital video signal Vd being read from the frame memory 12 into an analog video signal Va.

The data signal line drive circuit 3 includes a sampling switch control circuit 4, and m sampling switches SS1 to SSm. The sampling switch control circuit 4 outputs m switch control signals C1 to Cm based on the drive order control signal LR and the timing control signal TC2. The sampling switches SS1 to SSm are analog switches each being rendered conductive when the signal supplied to its control terminal is at a predetermined value (here, high level), and otherwise being rendered non-conductive. The sampling switches SS1 to SSm each have an analog video signal Va supplied to one end. The sampling switches SS1 to SSm each have their other end connected to their respective data signal lines S1 to Sm. The sampling switches SS1 to SSm each have one of the switch control signals C1 to Cm supplied to their respective control terminals.

The data signal line drive circuit 3 drives the data signal lines S1 to Sm in accordance with the one-fold pulse drive method. More specifically, the data signal line drive circuit 3 selects one of the data signal lines S1 to Sm in accordance with the disposition order, and applies the analog video signal Va to the selected data signal line.

The liquid crystal display device 10 has a function of changing the order of driving the data signal lines S1 to Sm, as described below. The drive order control circuit 14 generates the drive order control signal LR so as to periodically switch between high and low levels. The drive order control circuit 14 generates the drive order control signal LR based on, for example, a horizontal synchronization signal HSYNC and a vertical synchronization signal VSYNC. Note that the horizontal synchronization signal HSYNC and the vertical synchronization signal VSYNC may be generated within or externally supplied to the liquid crystal display device 10.

The drive order control signal LR is supplied to the sampling switch control circuit 4 included in the data signal line drive circuit 3. When the drive order control signal LR is at high level, the sampling switch control circuit 4 initially controls the switch control signal C1 to be at high level for one cycle in one line time, then controls the switch control signal C2 to be at high level for one cycle, and similarly controls each of the remaining switch control signals C3 to Cm to be at high level for one cycle in ascending order of their subscripts. On the other hand, when the drive order control signal LR is at low level, the sampling switch control circuit 4 initially controls the switch control signal Cm to be at high level for one cycle in one line time, then controls the switch control signal Cm−1 to be at high level for one cycle, and similarly controls each of the remaining switch control signals C1 to Cm−2 to be at high level for one cycle in descending order of their subscripts (see FIGS. 8 to 10 to be described later).

The sampling switches SS1 to SSm are rendered conductive when their respective switch control signals C1 to Cm are at high level. Accordingly, the data signal line drive circuit 3 drives the data signal lines S1 to Sm in ascending order of their subscripts (herein after, referred to as the “left-first drive”) when the drive order control signal LR is at high level, while driving the data signal lines S to Sm in descending order of their subscripts (herein after, referred to as the “right-first drive”) when the drive order control signal LR is at low level. In this manner, the data signal line drive circuit 3 periodically switches between driving the data signal lines S1 to Sm in the left-to-right direction in accordance with the disposition order, and driving them in the right-to-left direction in accordance with the disposition order.

The memory control circuit 15 changes the order of reading the digital video signals Vd from the frame memory 12 in units of one or more lines in accordance with the drive order control signal LR. More specifically, when an address for reading the digital video signal Vd used for driving the data signal line Si is Ai, the memory control circuit 15 outputs addresses A1 to Am in ascending order of their subscripts when the drive order control signal LR is at high level, while outputting the addresses A1 to Am in descending order of their subscripts when the drive order control signal LR is at low level. In this manner, the memory control circuit 15 changes the order of reading from the frame memory 12 in units of one or more lines in accordance with the order of driving the data signal lines S1 to Sm.

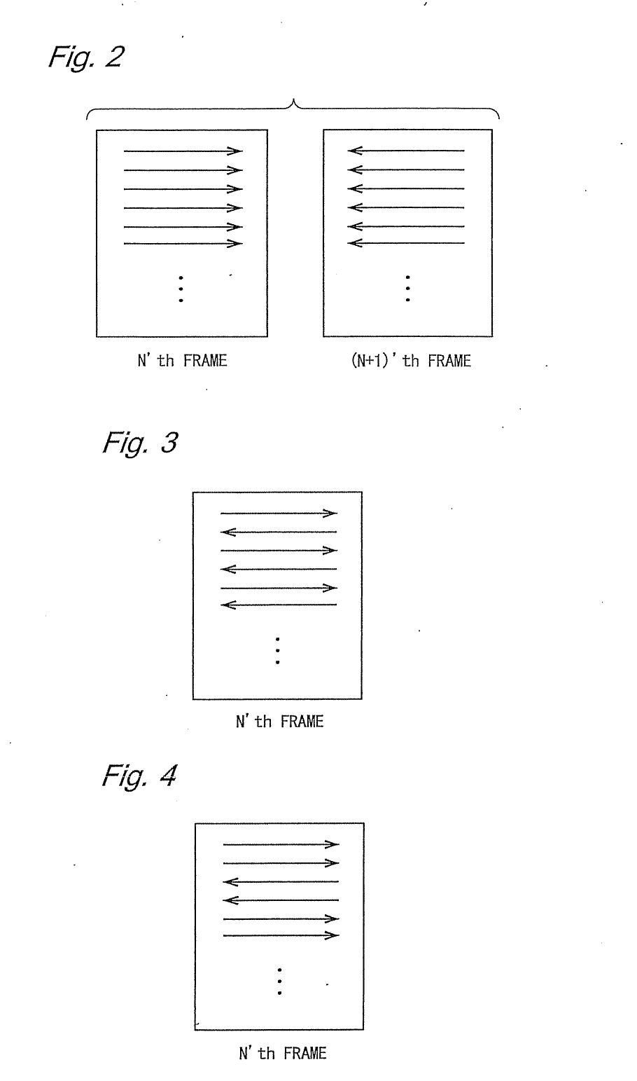

FIGS. 2 to 7 are diagrams illustrating exemplary orders of driving the data signal lines S1 to Sm in the liquid crystal display device 10. The drive order control circuit 14 may generate the drive order control signal LR so as to change every predetermined number of frame times. In this case, the order of driving the data signal lines S1 to Sm changes every predetermined number of frames. When the predetermined number is 1, the order of driving the data signal lines S1 to Sm is reversed every frame, as shown in FIG. 2. Specifically, when the left-first drive is performed for a frame (N'th frame) (left in FIG. 2), the right-first drive is performed for the next frame ((N+1)'th frame) (right in FIG. 2).

Alternatively, the drive order control circuit 14 may generate the drive order control signal LR so as to change every predetermined number of line times. In this case, the order of driving the data signal lines S1 to Sm changes every predetermined number of lines. When the predetermined number is 1, the order of driving the data signal lines S to Sm is reversed every line, as shown in FIG. 3. Specifically, the left-first drive is performed for odd-numbered lines, whereas the right-first drive is performed for even-numbered lines.

Also, when the predetermined number is 2, the order of driving the data signal lines S1 to Sm is reversed every two lines, as shown in FIG. 4. Specifically, when all the lines contained in the display screen are sequentially divided from the top into two alternating groups, each containing two consecutive lines, the left-first drive is performed for the lines in the first group, whereas the right-first drive is performed for the lines in the second group.

Alternatively, the drive order control circuit 14 may generate the drive order control signal LR so as to change every predetermined number of line times and have a value different from that in the immediately previous frame time. In this case, the order of driving the data signal lines S1 to Sm changes every predetermined number of lines and differs from the order in the immediately previous frame. When the predetermined number is 1, the order of driving the data signal lines S1 to Sm is reversed every line and also becomes opposite to the order in the immediately previous frame, as shown in FIG. 5. Specifically, when the left-first drive is performed for odd-numbered lines within a frame and the right-first drive is performed for even-numbered lines within the frame (left in FIG. 5), the right-first drive is performed for odd-numbered lines within the next frame, and the left-first drive is performed for even-numbered lines within the next frame (right in FIG. 5).

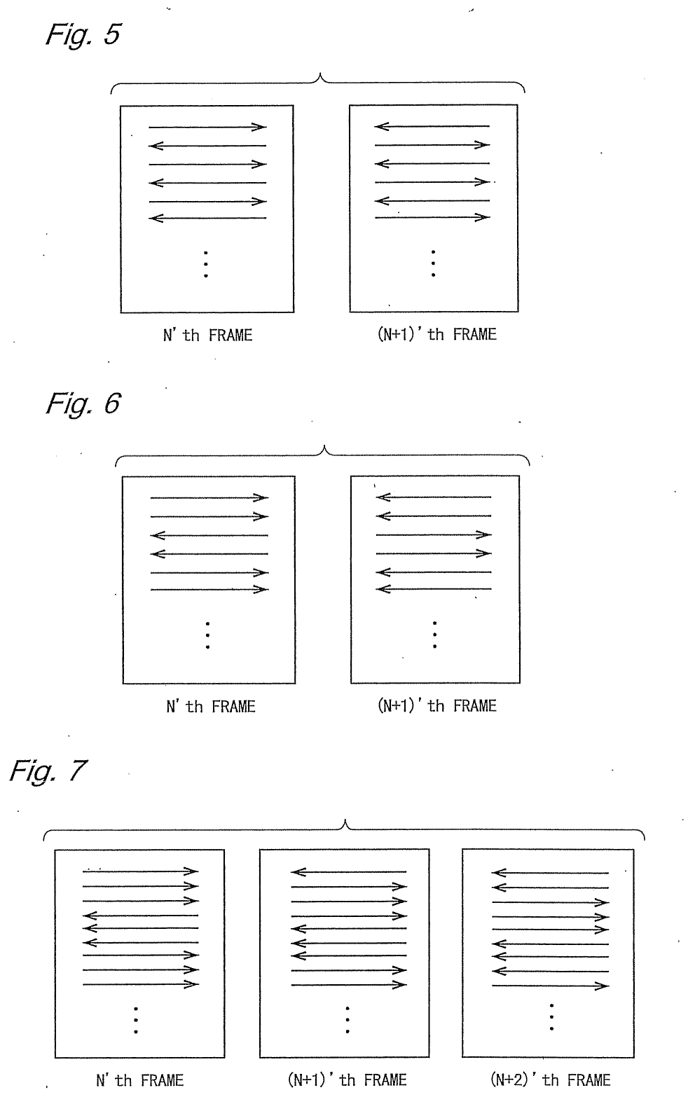

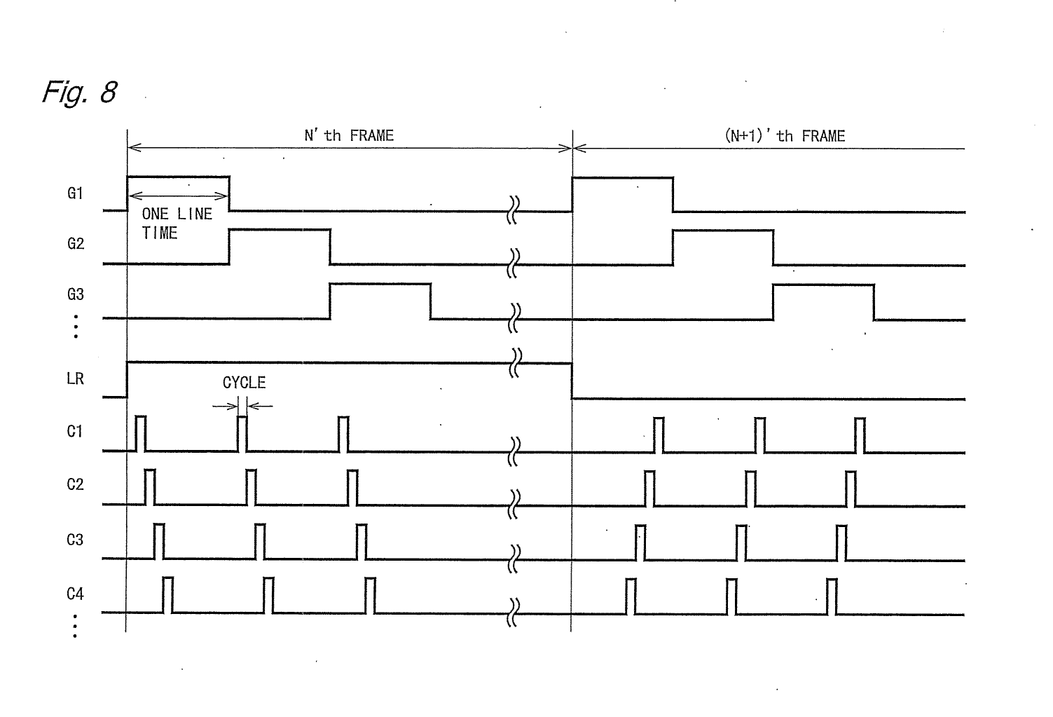

In addition, when the predetermined number is 2, the order of driving the data signal lines S1 to Sm is reversed every two lines and also becomes opposite to the order in the immediately previous frame, as shown in FIG. 6. Specifically, in the case where all the lines contained in the display screen are sequentially divided from the top into two alternating groups, each containing two consecutive lines, if the left-first drive is performed for lines in the first group within a frame and the right-first drive is performed for lines in the second group within the frame (left in FIG. 6), the right-first drive is performed for lines in the first group within the next frame, and the left-first drive is performed for lines in the second group within the next frame (right in FIG. 6).

Alternatively, the drive order control circuit 14 may generate the drive order control signal LR so as to change every predetermined number (M1) of line times in a pattern different from that in the immediately previous frame time. In this case, the order of driving the data signal lines S1 to Sm changes every M1 lines in a pattern different from that in the immediately previous frame. Particularly, the drive order control circuit 14 may generate the drive order control signal LR so as to change in a pattern different by a predetermined number of (M2) line times from that in the immediately previous frame time. In this case, the order of driving the data signal lines S1 to Sm changes in a pattern different by M2 lines from that in the immediately previous frame.

When M1 is 3 and M2 is 1, the order of driving the data signal lines S1 to Sm changes as shown in FIG. 7. Specifically, when the left-first drive is performed for the first to third lines, etc., within a frame and the right-first drive is performed for the fourth to sixth lines, etc., within the frame (left in FIG. 7), the left-first drive is performed for the second to fourth lines, etc., within the next frame and the right-first drive is performed for the first line, the fifth to seventh lines, etc., within the next frame (center in FIG. 7); and the left-first drive is performed for the third to fifth lines, etc., within the further next frame ((N+2)'th frame) and the right-first drive is performed for the first and second lines, the sixth to eighth lines, etc., within the further next frame (right in FIG. 7).

Note that the drive order control circuit 14 may generate the drive order control signal LR so as to change in periods other than the above-described periods. In such a case, the order of driving the data signal lines S1 to Sm periodically switches between the left-to-right direction in the disposition order and the right-to-left direction in the disposition order. The value used for the period of the drive order control signal LR is set to an integral multiple of one line time that reduces the visibility of any ghost generated on the display screen.

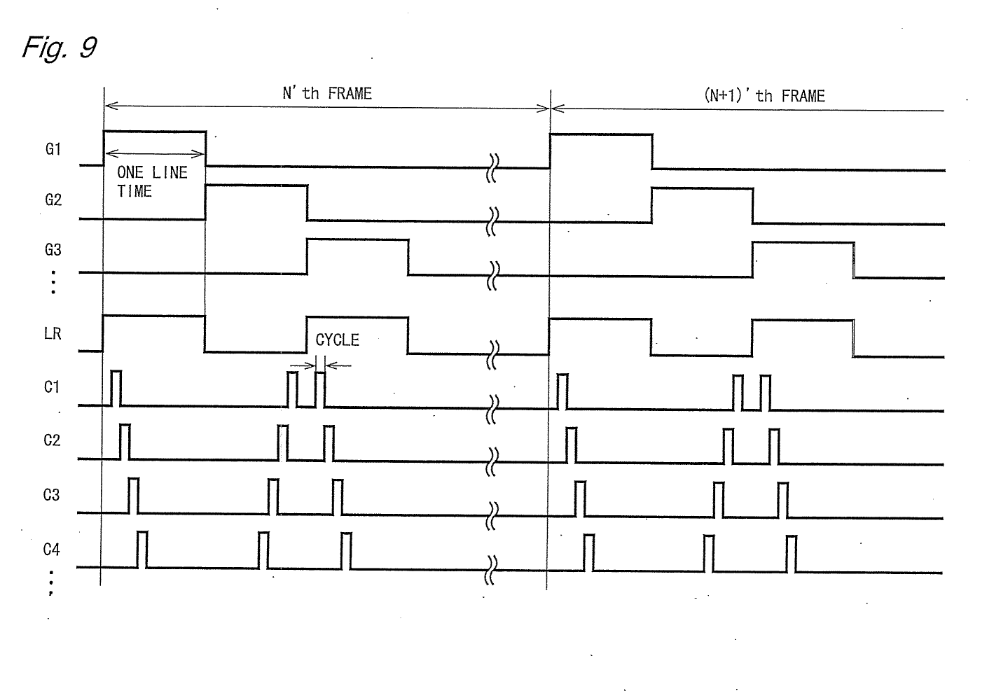

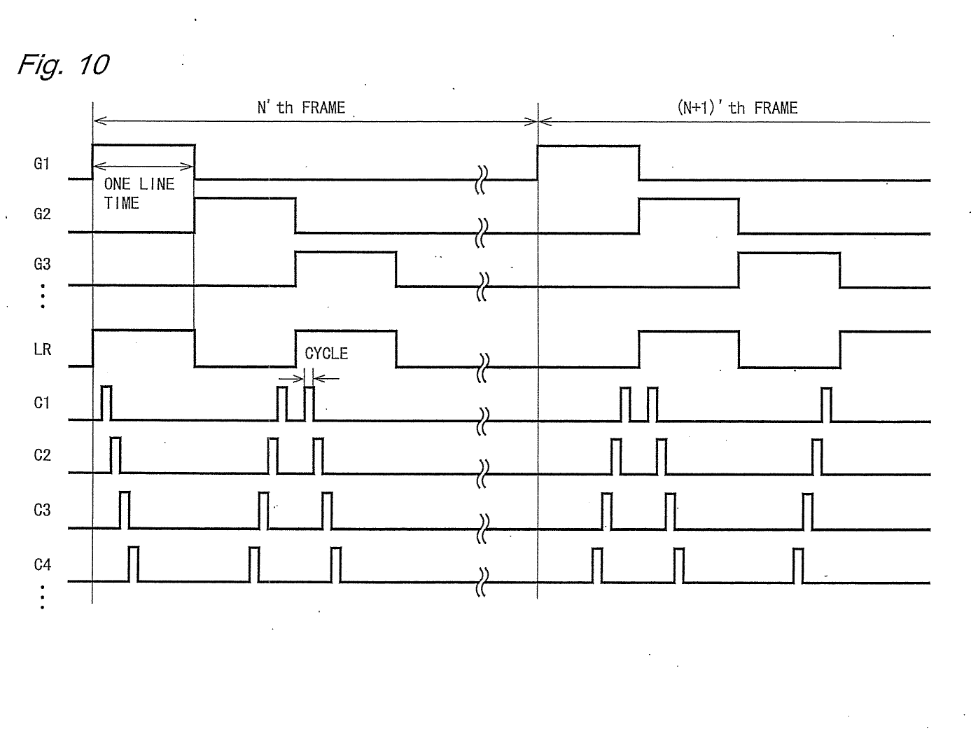

FIGS. 8 to 10 are timing charts for the liquid crystal display device 10. FIG. 8 is a timing chart in the case where the order of driving the data signal lines S1 to Sm changes every frame (FIG. 2). FIG. 9 is a timing chart in the case where the order of driving the data signal lines S1 to Sm changes every line (FIG. 3). FIG. 10 is a timing chart in the case where the order of driving the data signal lines S1 to Sm changes every line and differs from that in the immediately previous frame (FIG. 5).

In each frame time, first, the scanning signal line G1 is set to high level for one line time, then the scanning signal line G2 is set to high level for one line time, and thereafter, each of the remaining scanning signal lines G3 to Gn is similarly set to high level for one line time in ascending order of their subscripts, as shown in FIGS. 8 to 10. The switch control signals C1 to Cm are normally at low level, and set to high level for one cycle during one line time. The switch control signals C1 to Cm are brought into high level in ascending order of their subscripts when the drive order control signal LR is at high level, and they are brought into high level in descending order of their subscripts when the drive order control signal LR is at low level.

In the example shown in FIG. 8, the drive order control signal LR is at high level in the N'th frame, and at low level in the (N+1)'th frame. Accordingly, the switch control signals C1 to Cm are set to high level for one cycle during each line time within the N'th frame in ascending order of their subscripts, and they are set to high level for one cycle during each line time within the (N+1)'th frame in descending order of their subscripts. Thus, the left-first drive is performed for the N'th frame (see left in FIG. 2), and the right-first drive is performed for the (N+1)'th frame (see left in FIG. 2).

In the example shown in FIG. 9, the drive order control signal LR is at high level during odd-numbered line times, and at low level during even-numbered line times. Accordingly, the switch control signals C1 to Cm are set to high level for one cycle during the odd-numbered line times in ascending order of their subscripts, and they are set to high level for one cycle during the even-numbered line times in descending order of their subscripts. Thus, the left-first drive is performed for the odd-numbered lines, and the right-first drive is performed for the even-numbered lines (see FIG. 3).

In the example shown in FIG. 10, the drive order control signal LR is at high level during the odd-numbered line times within the N'th frame and during the even-numbered line times within the (N+1)'th frame, and at low level during the even-numbered line times within the N'th frame and during the odd-numbered line times within the (N+1)'th frame. Accordingly, the switch control signals C1 to Cm are set to high level for one cycle during the odd-numbered line times within the N′th frame and during the even-numbered line times within the (N+1)'th frame in ascending order of their subscripts, whereas they are set to high level for one cycle during the even-numbered line times within the N'th frame and during the odd-numbered line times within the (N+1)'th frame in descending order of their subscripts. Thus, the left-first drive is performed for the odd-numbered lines within the N'th frame, and the right-first drive is performed for the even-numbered lines within the N'th frame (see left in FIG. 5). In addition, the right-first drive is performed for the odd-numbered lines within the (N+1)'th frame, and the left-first drive is performed for the even-numbered lines within the (N+1)'th frame (see right in FIG. 5).

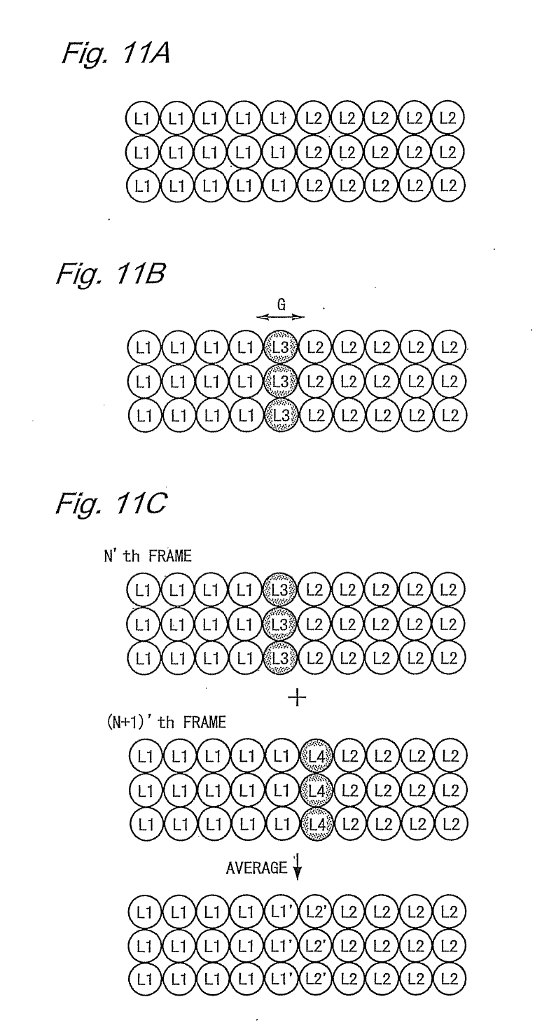

Referring to FIGS. 11A to 11C, effects of the liquid crystal display device 10 will be described below. In FIGS. 11A to 11C, circles represent pixels contained in the display screen, and characters indicated within the circles represent pixel luminance levels. FIG. 11A is an enlarged view of an ideal display screen. The ideal display screen contains a portion consisting of pixels at luminance level L1 and a portion consisting of pixels at luminance level L2.

In conventional liquid crystal display devices performing dot-sequential drive, the order of driving data signal lines is fixed in a specific direction (left-to-right direction in the figures). Therefore, the rightmost pixel in each line, which should be at luminance level L1, is affected by its adjacent pixel on the right at luminance level L2, so that the luminance level changes to L3 (see FIG. 11B). If such pixels having their luminance levels changed from L1 to L3 concentrate within the display screen, humans would perceive a ghost being generated in that portion (range G shown in FIG. 11B).

On the other hand, in the case of the liquid crystal display device 10 in which the order of driving the data signal lines changes every frame, when the left-first drive is performed for a frame, the right-first drive is performed for the next frame, as shown in FIG. 2. When the left-first drive is performed, the rightmost pixel in each line, which should be at luminance level L1, is affected by its adjacent pixel on the right at luminance level L2, so that the luminance level changes to L3. Also, when the right-first drive is performed, the left most pixel in each line, which should be at luminance level L2, is affected by its adjacent pixel on the left at luminance level L1, so that the luminance level changes to L4 (see FIG. 11C).

Since frames change at high speed, humans would perceive as the display screen an average between the display screen by the left-first drive and the display screen by the right-first drive. Accordingly, in the display screen perceived by humans, the rightmost pixel in each line, which should be at luminance level L1, has a luminance level L1′, an average between L1 and L3, whereas the leftmost pixel in each line, which should be at luminance level L2, has a luminance level L2′, an average between L2 and L4. L1′ is closer to L1 than L3, and L2′ is closer to L2 than L4. Accordingly, the liquid crystal display device 10 in which the order of driving the data signal lines changes every frame can disperse any ghost generated on the display screen in the temporal direction, thereby reducing the visibility of the ghost.

Similar effects can also be achieved by the liquid crystal display device 10 in which the order of driving the data signal lines changes in periods other than one frame. Concretely, the liquid crystal display device 10 in which the order of driving the data signal lines changes every predetermined number of frames (FIG. 2) can disperse any ghost generated on the display screen in the temporal direction, thereby reducing the visibility of the ghost. In addition, the liquid crystal display device 10 in which the order of driving the data signal lines changes every predetermined number of lines (FIGS. 3 and 4) can disperse any ghost generated on the display screen in the scanning signal line direction, thereby reducing the visibility of the ghost. Also, the liquid crystal display device 10 in which the order of driving the data signal lines changes every predetermined number of lines and differs from that in the immediately previous frame (FIGS. 5 and 6) or in which the order of driving the data signal lines changes every predetermined number of lines in a pattern different from that in the immediately previous frame (FIG. 7) can disperse any ghost generated on the display screen in both the temporal direction and the scanning signal line direction, thereby reducing the visibility of the ghost.

As described above, in the liquid crystal display device 10 according to the present embodiment, the order of driving the data signal lines periodically switches between the order of disposition in the first direction and the order of disposition in the second direction. In liquid crystal display devices performing dot-sequential drive, the place where the ghost is generated on the display screen depends on the order of driving the data signal lines. Accordingly, by changing the order of driving the data signal lines, it becomes possible to disperse any ghost generated on the display screen in the temporal and/or spatial directions, thereby reducing the visibility of the ghost. As a result, it is possible to prevent any ghost from being generated on the display screen in a simple manner other than the two-fold pulse drive method. The present embodiment is applicable to any liquid crystal display device with a frame memory.

### Second Embodiment

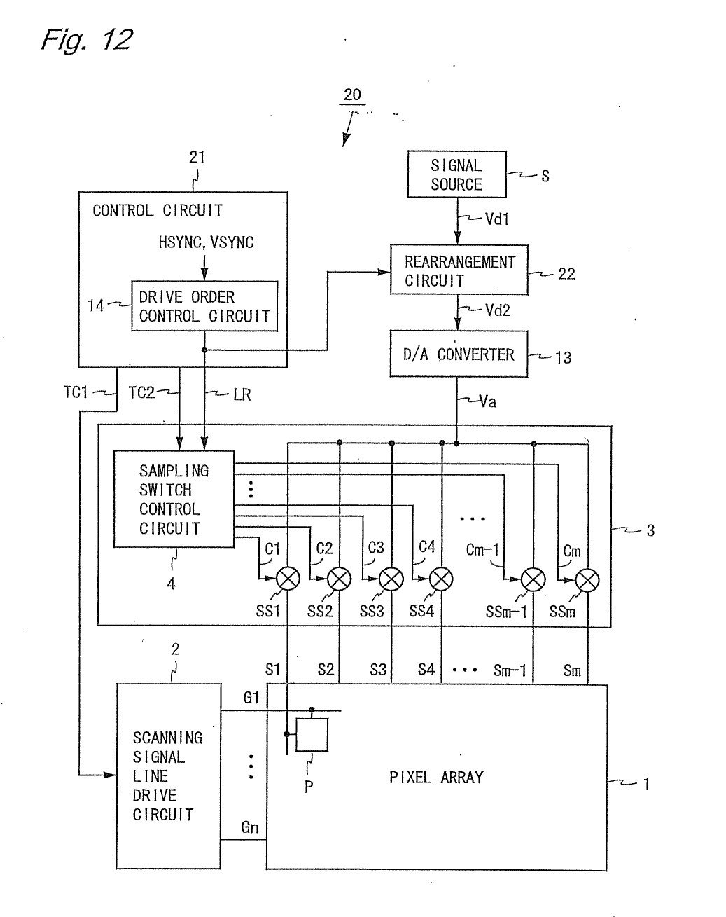

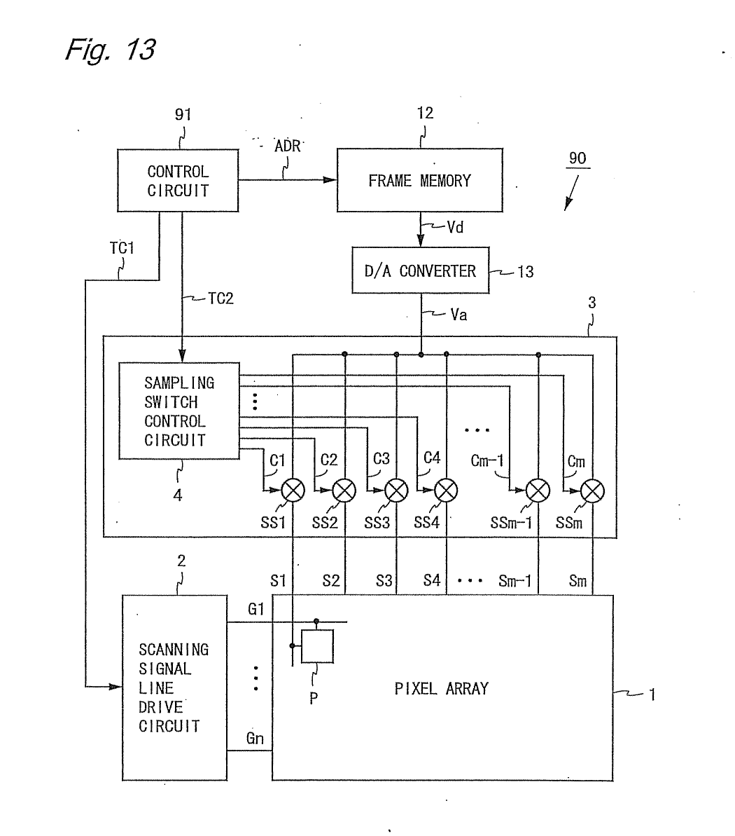

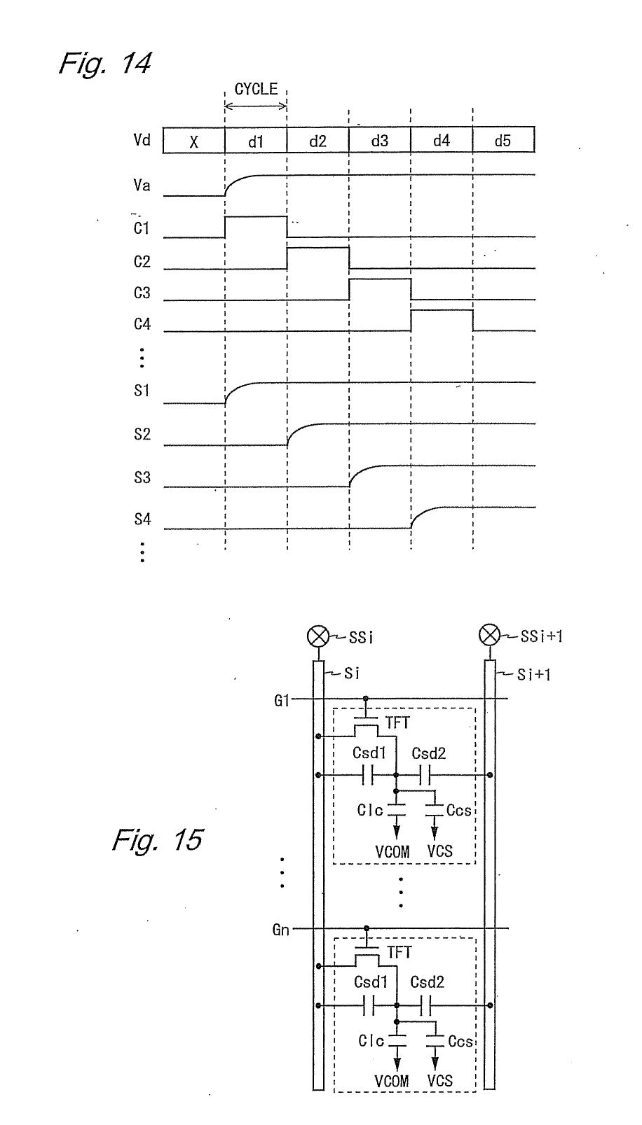

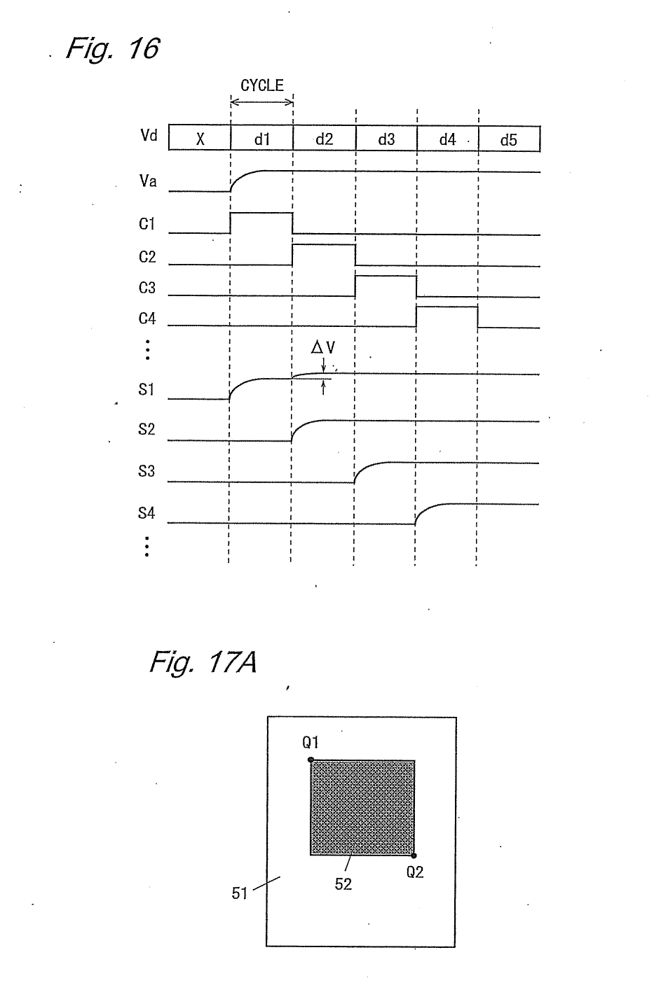

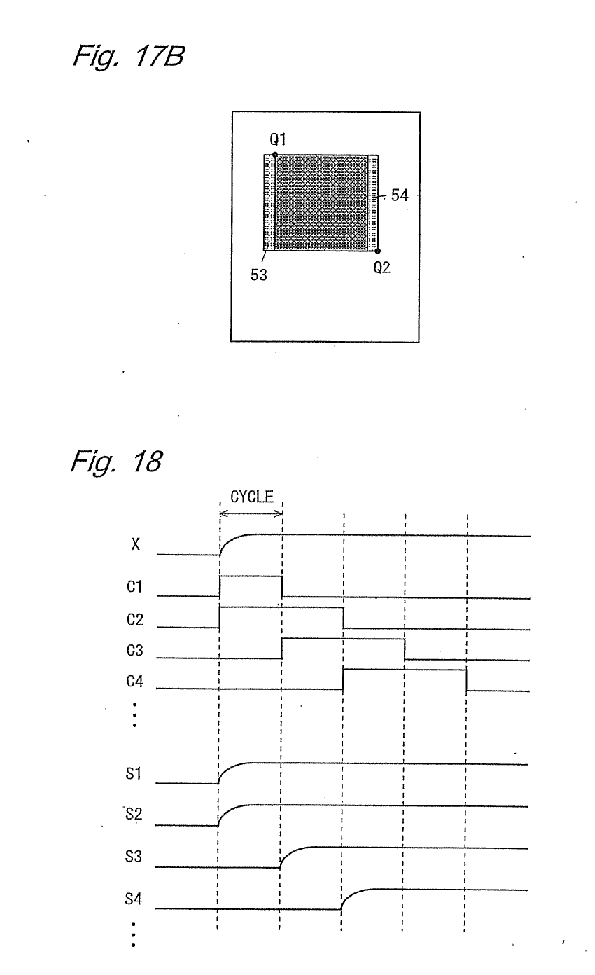

FIG. 12 is a block diagram illustrating the configuration of a liquid crystal display device according to a second embodiment of the present invention. The liquid crystal display device 20 shown in FIG. 12 includes a pixel array 1, a scanning signal line drive circuit 2, a data signal line drive circuit 3, a control circuit 21, a rearrangement circuit 22, and a D/A converter 13. The control circuit 21 includes a drive order control circuit 14. In FIG. 12, the rearrangement circuit 22 and the D/A converter 13 collectively function as a video signal output portion. In the present embodiment, the same elements as in the first embodiment are denoted by the same reference characters, and any descriptions thereof will be omitted.

The liquid crystal display device 20 is used with and connected to a signal source S for sequentially outputting digital video signals Vd1. The rearrangement circuit 22 includes two line memories, each memorizing the digital video signal Vd1 for one line. The rearrangement circuit 22 performs a process for writing the digital video signals Vd1 sequentially outputted from the signal source S to one line memory, in parallel with a process for reading digital video signals Vd2 from the other line memory. Note that the rearrangement circuit 22 may have a capacity of memorizing the digital video signal Vd1 for more than two lines.

The drive order control circuit 14 generates a periodically-changing drive order control signal LR, as in the first embodiment. When the drive order control signal LR is at high level, the rearrangement circuit 22 reads and outputs the digital video signals from the line memory in the same order as that when they were inputted. On the other hand, when the drive order control signal LR is at low level, the rearrangement circuit 22 reads and outputs the digital video signals from the line memory in the reverse order from that when they were inputted. Concretely, when the drive order control signal LR is at low level, the rearrangement circuit 22 may reverse either the order of reading from or writing to the line memory from that when the drive order control signal LR is at high level.

In this manner, the rearrangement circuit 22 temporarily memorizes the digital video signals Vd1 sequentially outputted from the signal source S, and outputs the memorized digital video signals Vd2 in units of one or more lines in the same order as or reverse order from that when they were inputted, in accordance with the order of driving the data signal lines S1 to Sm. The D/A converter 13 converts the digital video signals Vd2 outputted from the rearrangement circuit 22 into analog video signals Va.

As described above, in the liquid crystal display device 20 according to the present embodiment, the order of driving the data signal lines can be periodically switched between the order of disposition in the first direction and the order of disposition in the second direction, as in the first embodiment. Accordingly, as in the first embodiment, it is possible to disperse any ghost generated on the display screen in the temporal and/or spatial directions, thereby reducing the visibility of the ghost. Thus, it is possible to prevent any ghost from being generated on the display screen in a simple manner other than the two-fold pulse drive method. The present embodiment is applicable to any display device used with and connected to a signal source for sequentially outputting digital video signals.

While the liquid crystal display devices according to the first and second embodiments have been described above as employing the one-fold pulse drive method to drive the data signal lines S1 to Sm, the data signal lines S1 to Sm may be driven in accordance with the two-fold pulse drive method. Such a liquid crystal display device can more effectively prevent any ghost from being generated on the display screen by taking advantage of the effect achieved by changing the order of driving the data signal lines and the effect achieved by the two-fold pulse drive method.

Also, while the liquid crystal display devices according to the first and second embodiments have been described above as performing dot-sequential drive based on only one analog video signal Va at a time, the present invention is also applicable to any liquid crystal display devices performing dot-sequential drive based on more than one analog video signal at a time. Concretely, in the case of a liquid crystal display device generally performing dot-sequential drive based on q analog video signals (where q is an integer of 1 or higher), the video signal output portion may change the order of driving the data signal lines every q data signal lines in accordance with the drive order control signal LR.

The present invention is also applicable to any matrix-type display devices other than the liquid crystal display device.

### INDUSTRIAL APPLICABILITY

The display device of the present invention can prevent any ghost from being generated on the display screen when performing dot-sequential drive, and therefore can be used as any matrix-type display device, including the liquid crystal display device.

1. A matrix-type display device performing dot-sequential drive, comprising:
a pixel array including a plurality of display elements disposed in row and column directions, a plurality of scanning signal lines, each being commonly connected to display elements disposed in the same row, and a plurality of data signal lines, each being commonly connected to display elements disposed in the same column;
a scanning signal line drive circuit for selectively activating the scanning signal lines;
a video signal output portion for sequentially outputting analog video signals to be supplied to the display elements; and
a data signal line drive circuit for driving the data signal lines in accordance with their disposition order based on the analog video signals,
wherein the data signal line drive circuit periodically switches between driving the data signal lines in accordance with the order of disposition in a first direction and driving the data signal lines in accordance with the order of disposition in a second direction, and
wherein the video signal output portion changes the order of outputting the analog video signals in accordance with the order of driving the data signal lines.

2. The display device according to claim 1, wherein the order of driving the data signal lines changes every predetermined number of frames.

3. The display device according to claim 1, wherein the order of driving the data signal lines changes every predetermined number of lines.

4. The display device according to claim 1, wherein the order of driving the data signal lines changes every predetermined number of lines and differs from that in an immediately previous frame.

5. The display device according to claim 1, wherein the order of driving the data signal lines changes every predetermined number of lines in a pattern different from that in an immediately previous frame.

6. The display device according to claim 5, wherein the order of driving the data signal lines changes in a pattern different by a predetermined number of lines from that in the immediately previous frame.

7. The display device according to claim 1,
wherein the video signal output portion includes:
a frame memory for memorizing a digital video signal for at least one frame;
a memory control circuit for reading the digital video signal from the frame memory; and
a D/A converter for converting the digital video signal being read from the frame memory into the analog video signal, and
wherein the memory control circuit changes the order of reading from the frame memory in units of one or more lines in accordance with the order of driving the data signal lines.

8. The display device according to claim 1,
wherein the video signal output portion includes:
a rearrangement circuit for temporarily memorizing digital video signals sequentially outputted from a signal source, and outputting the memorized digital video signals in units of one or more lines in the same order as or reverse order from that when they were inputted, in accordance with the order of driving the data signal lines; and
a D/A converter for converting the digital video signals being read from the rearrangement circuit into the analog video signals.

9. A method for driving data signal lines in a display device with a pixel array including a plurality of display elements disposed in row and column directions, a plurality of scanning signal lines, each being commonly connected to display elements disposed in the same row, and a plurality of data signal lines, each being commonly connected to display elements disposed in the same column, the method comprising the steps of:
sequentially outputting analog video signals to be supplied to the display elements; and
driving the data signal lines in accordance with their disposition order based on the analog video signals,
wherein in the step of driving the data signal lines, switching is periodically performed between driving the data signal lines in accordance with the order of disposition in a first direction and driving the data signal lines in accordance with the order of disposition in a second direction, and
wherein in the step of outputting the analog video signals, the order of outputting the analog video signals is changed in accordance with the order of driving the data signal lines.
